(19) United States
(12) Patent Application Publication
(10) Pub. No.: US 2008/0188607 A1
(43) Pub. Date: Aug. 7, 2008

(54) LOW ODOR RESIN COMPOSITIONS

(75) Inventors: William Guerrieri, Durham, PA (US); Stephen Michalik, Beaver, PA (US)

Correspondence Address: NOVA Chemicals Inc., Westpointe Center, 1550 Coraopolis Heights Road, Moon Township, PA, 15108, US

(73) Assignee: NOVA CHEMICALS INC., Moon Township, PA (US)

(21) Appl. No.: 11/971,247

(22) Filed: Jan. 9, 2008

Related U.S. Application Data
(60) Provisional application No. 60/899,992, filed on Feb. 7, 2007.

(51) Int. Cl. C08K 3/34

(52) U.S. Cl. 524/447; 524/445; 524/451; 524/450

(57) ABSTRACT

A method of reducing the odor of a resin that includes the step of adding about 0.1% to about 10% by weight of an absorbent clay to the resin. A resin composition with low odor is provided that includes 60% to 99.9% of a styrenic polymer; optionally 0.1% to 30% of one or more elastomeric polymers; and 0.1% to 10% of an absorbent clay. The styrenic polymer is formed by polymerizing a mixture containing 35% to 100% by weight of one or more styrenic monomers, optionally 1% to 49% by weight of one or more maleate-type monomers, and optionally 1% to 65% by weight of one or more other polymerizable monomers. The resin composition and/or method can be used to make molded articles or a resin foam.

### REFERENCE TO RELATED APPLICATION

This application claims the benefit of priority of U.S. Provisional Application Ser. No. 60/899,992 filed Feb. 7, 2007 entitled “Low Odor Resin Compositions” which is herein incorporated by reference in its entirety.

### BACKGROUND OF THE INVENTION

1 . Field of the Invention

The present invention is directed to thermoplastic resin compositions, containing styrenic polymers, useful for being molded into various articles.

2. Description of the Prior Art

Vinyl aromatic resins, such as polystyrene or high impact polystyrene have been found to be useful in thermoplastic molding compositions. However, such vinyl aromatic resins have poor heat distortion and impact resistance. One approach to improve these property deficiencies involves copolymerizing the vinyl aromatic with maleic anhydride to form copolymers.

In order to further improve the properties of such vinyl aromatic copolymers, various other polymers have been blended with the copolymer. For example, blends of nitrile rubber and styrene-maleic anhydride copolymers are disclosed in U.S. Pat. Nos. 2,914,505 and 3,641,212. Blends of styrene-maleic anhydride copolymers with radial styrene-diene block copolymers and an optional polyphenylene ether resin are disclosed in U.S. Pat. No. 4,097,550. Still further, blends of styrene-maleic anhydride copolymers, hydrogenated styrene-diene block copolymers and optional polyphenylene ether resins are disclosed in U.S. Pat. Nos. 4,124,654 and 4,243,766.

U.S. Pat. No. 4,377,647 discloses molding compositions containing a blend of styrene-maleic anhydride copolymers, selectively hydrogenated monoalkenyl arene-conjugated diene block copolymers, and a thermoplastic polyester.

Many polymers containing styrene and/or maleic anhydride and rubber-modified polymers containing styrene and/or maleic anhydride have been used in molded parts for use in automobiles.

As an example, U.S. Pat. No. 4,188,440 discloses a contoured self-supporting automotive liner panel that includes an outer substrate layer, an intermediate layer and an outer flexible, decorative, finish cover layer. The substrate layer is formed from an expanded styrene-maleic anhydride copolymer.

U.S. Pat. No. 4,256,797 discloses a contoured vehicle trim panel that includes a composite laminar sheet consisting of a pair of inperforate thermoplastic films bonded to the face surfaces of an intervening coextensive thermoplastic foam layer consisting of a modified styrene-maleic anhydride copolymer.

U.S. Pat. No. 4,851,283 discloses thermoformable laminates, suitable for use as automobile headliners, that contain a layer of non-woven fabric bonded to one side of a foamed sheet containing a polystyrene copolymer, such as a styrene-maleic anhydride copolymer. The combination provides an optimum balance of characteristics including cost and improved sound absorption characteristics especially, for compact and subcompact automobile uses.

While the thermal properties and strength properties of polystyrene and copolymers of styrene provide desirable properties in molded parts for use in automobiles, it has been speculated that possible volatile organic compound (VOC) emissions could create issues around the use of polystyrene and copolymers in interior parts for automobiles. The potential issues concern the possible health effects resulting from repeated exposure to VOC's, which has caused some automakers to consider not using molded parts containing polystyrene and copolymers of styrene.

As a particular example, the Verband des Automobilindustrie (VDA), the German quality management system for the automobile industry established VDA 278, a standard for organic emissions testing. Regulatory agencies such as the Californian Air Resources Board (CARB) and EPA are also looking closely at VOC's in automobile interiors. Many automobile manufacturers have established or are considering establishing specifications complying with the VDA standrads, such as Audi, BMW, DaimlerChrysler, General Motors, Jaguar, Porsche, Rols Royce, Saab, Toyota, Volvo, and Volkswagon. Thus the VOC emission behaviour of car interior materials is a growing concern.

There is a need in the art for moldable polystyrene and copolymers of styrene that can be incorporated into parts for automobile interiors that have reduced or minimized VOC's while maintaining desirable thermal and strength properties.

### SUMMARY OF THE INVENTION

The present invention provides a method of reducing the odor of a resin that includes the step of adding about 0.1% to about 10% by weight of an absorbent clay to the resin.

The present invention further provides a resin composition that includes about 60% to about 99.9% by weight of a styrenic polymer; optionally about 0.1% to about 30% by weight of one or more elastomeric polymers; and about 0.1% to about 10% by weight of an absorbent clay. The styrenic polymer is formed by polymerizing a mixture containing about 35% to about 100% by weight of one or more styrenic monomers, optionally about 1% to about 49% by weight of one or more maleate-type monomers, and optionally about 1% to about 65% by weight of one or more other polymerizable monomers.

The present invention additionally provides a molded article that includes the above described resin composition and/or is made according to the above-described method.

The present invention also provides a resin foam that includes the above described resin composition and/or is made according to the above-described method.

### DETAILED DESCRIPTION OF THE INVENTION

Other than in the operating examples or where otherwise indicated, all numbers or expressions referring to quantities of ingredients, reaction conditions, etc. used in the specification and claims are to be understood as modified in all instances by the term “about”. Accordingly, unless indicated to the contrary, the numerical parameters set forth in the following specification and attached claims are approximations that can vary depending upon the desired properties, which the present invention desires to obtain. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

As used herein, the terms “(meth)acrylic” and “(meth)acrylate” are meant to include both acrylic and methacrylic acid derivatives, such as the corresponding alkyl esters often referred to as acrylates and (meth)acrylates, which the term “(meth)acrylate” is meant to encompass.

As used herein, the term “polymer” is meant to encompass, without limitation, homopolymers, copolymers and graft copolymers.

As used herein, the term “copolymer” refers to a polymer formed by polymerizing a monomer mixture containing two or more polymerizable monomers.

As used herein, the term “elastomeric polymers” refers to natural or synthetic polymers that have the ability to undergo deformation under the influence of force and regain their original shape once the force is removed.

As used herein, the term “high impact polystyrene” refers to rubber-modified polystyrene as is known in the art. Also, “crystal polystyrene” refers to polystyrene that does not contain other polymers.

As used herein, “rubber-modified copolymers of styrene and maleic anhydride” refer to polymer compositions that include copolymers of styrene and maleic anhydride and one or more elastomeric polymers.

Unless otherwise specified, all molecular weight values are determined using gel permeation chromatography (GPC) using appropriate polystyrene standards. Unless otherwise indicated, the molecular weight values indicated herein are weight average molecular weights (Mw).

As used herein, the term “thermoplastic” refers to materials that are capable of softening, fusing, and/or modifying their shape when heated and of hardening again when cooled.

As used herein, the term “absorbent clay” refers to mineral particles that are capable of taking up a liquid, a vapor, a gas or combinations thereof.

The present invention is directed to a method of reducing the odor of a resin that includes the step of adding an absorbent clay to a polymer or resin. In particular embodiments, the invention provides polymers or resins that include a styrenic polymer; optionally one or more elastomeric polymers; and an absorbent clay. The styrenic polymer is formed by polymerizing a mixture containing one or more styrenic monomers, optionally one or more maleate-type monomers, and optionally one or more other polymerizable monomers.

The styrenic polymer can be present in the polymers or resins at a level of at least about 60%, in some cases at least about 65%, and in other cases at least about 70% and can be present at up to about 99.9%, in some cases up to about 99.8%, in other cases up to about 99%, in some instances up to about 95%, in other instances up to about 90%, and in some situations up to about 88% by weight based on the polymer or resin composition. The styrenic polymer can be present in the polymers or resins at any level or can range between any of the values recited above.

The styrenic monomers can be present in the polymerization mixture and/or the formed polymer at a level of at least 35%, in some instances at least 40%, in other instances at least 45%, in some situations at least 50%, in some cases at least 55% and in other cases at least 60% and can be present at 100% or up to 99.9%, in particular cases up to 99.8%, in some cases up to 95%, in other cases up to 90%, in some situations up to 85%, in other situations up to 80%, and in some instances up to 75% by weight based on the polymerization mixture and/or the resin composition. The styrenic monomers can be present in the polymerization mixture and/or the resin composition at any level or can range between any of the values recited above.

Any suitable styrenic monomer can be used in the invention. Suitable styrenic monomers are those that provide the desirable properties in the present thermoplastic sheet as described below. Non-limiting examples of suitable styrenic monomers include styrene, p-methyl styrene, α-methyl styrene, tertiary butyl styrene, dimethyl styrene, nuclear brominated or chlorinated derivatives thereof and combinations thereof.

The maleate-type monomers are optionally present in the polymerization mixture and/or resin composition. In embodiments of the invention, the maleate-type monomers are present at a level of at least 1%, in some cases at least 5%, in other cases at least 10% and in some instances at least 15% and can be present at up to 49%, in some cases up to 45%, in other cases up to 40%, in some situations up to 35% and in other situations up to 30% by weight based on the polymerization mixture and/or resin composition. The maleate-type monomers can be present in the polymerization mixture and/or resin composition at any level or can range between any of the values recited above.

Any suitable maleate-type monomer can be used in the invention. Suitable maleate-type monomers are those that provide the desirable properties in the present thermoplastic sheet as described below and include anhydrides, carboxylic acids and alkyl esters of maleate-type monomers, which include, but are not limited to maleic acid, fumaric acid and itaconic acid. Specific non-limiting examples of suitable maleate-type monomers include maleic anhydride, maleic acid, fumaric acid, C₁-C₁₂ linear, branched or cyclic alkyl esters of maleic acid, C₁-C₁₂ linear, branched or cyclic alkyl esters of fumaric acid, itaconic acid, C₁-C₁₂ linear, branched or cyclic alkyl esters of itaconic acid, and itaconic anhydride.

The other monomers are optionally present in the polymerization mixture and/or resin composition. In embodiments of the invention, the other monomers are present at a level of at least 0.01%, in some cases at least 0.1%, in other cases at least 1%, and in some instances at least 5% and can be present at up to 65%, in some instances up to 50%, in other instances up to 40%, in particular instances up to 30%, in some cases up to 25%, in other cases up to 20%, in some situations up to 15% and in other situations up to 10% by weight based on the polymerization mixture and/or resin composition. The other monomers can be present in the polymerization mixture and/or resin composition at any level or can range between any of the values recited above.

The other monomers can include any other monomers that are able to copolymerize with the styrenic monomers and optionally maleate-type monomers. Non-limiting examples of suitable other monomers include divinylbenzene; conjugated dienes, such as 1,3-butadiene, 1,3-pentadiene, 1,3-hexadiene, 2,4-hexadiene, 1,3-octadiene, and 2,4-octadiene; alkyl methacrylates, such as C₁-C₁₂ linear, branched or cyclic alkyl esters of methacrylic acid; alkyl acrylates, such as C₁-C₁₂ linear, branched or cyclic alkyl esters of acrylic acid, acrylonitrile; methacrylonitrile; alpha olefins, such as C₁-C₃₂ linear or branched 1-alkenes, and combinations thereof.

When the polymerization mixture is polymerized, a homopolymer of styrenic monomer is formed or a copolymer of styrenic monomers, and optionally maleate-type monomers and optionally other monomers is formed. When the elastomeric polymers are used, they are combined with the formed homopolymers and/or copolymers either in-situ or by blending or other compounding methods.

In embodiments of the invention, the elastomeric polymers can be included in the polymerization mixture.

In other embodiments of the invention, after the polymerization mixture is polymerized to form a polymer or copolymer, the elastomeric polymers can be combined with the polymer or copolymer by physical blending, compounding, or other methods.

When included, the elastomeric polymers are present at a level of at least 0.1%, in some cases at least 0.5%, in other cases at least 1%, in some instances at least 2% and in other instances at least 5% and can be present at up to 30%, in some cases up to 25%, in other cases up to 20%, and in some situations up to 15% by weight based on the weight of the polymerization mixture or resin composition. The elastomeric polymers can be present at any level or can range between any of the values recited above.

Any suitable elastomeric polymer can be used in the invention. In some embodiments of the invention, combinations of elastomeric polymers are used to achieve desired properties. Suitable elastomeric polymers are those that provide the desirable properties in articles made from the present resin composition as described below and are desirably capable of resuming their shape after being deformed.

In an embodiment of the invention, the elastomeric polymers include, but are not limited to homopolymers of butadiene or isoprene or other conjugated dienes, and random, block, AB diblock, or ABA triblock copolymers of a conjugated diene (non-limiting examples being butadiene and/or isoprene) and a styrenic monomer as defined above and/or acrylonitrile; alpha olefins (non-limiting examples being ethylene, propylene, 1-butene, 1-pentene, 1-hexene, and 1-octene) and C₁-C₃₂ linear, branched and/or cyclic alkyl esters of (meth)acrylic acid.

In a particular embodiment of the invention, the elastomeric polymers include one or more block copolymers selected from diblock and triblock copolymers of styrene-butadiene, styrene-butadiene-styrene, styrene-isoprene, styrene-isoprene-styrene, partially hydrogenated styrene-isoprene-styrene, acrylonitrile-butadiene-styrene, and random copolymers of ethylene and methyl (meth)acrylate and combinations thereof.

As used herein, butadiene refers to 1,3-butadiene and when polymerized, to repeat units that take on the 1,4-cis, 1,4-trans and 1,2-vinyl forms of the resulting repeat units along a polymer chain.

In an embodiment of the invention, the elastomeric polymer has a number average molecular weight (Mn) greater than 12,000, in some cases greater than 15,000, and in other cases greater than 20,000 and a weight average molecular weight (Mw) of at least 25,000 in some cases not less than about 50,000, and in other cases not less than about 75,000 and the Mw can be up to 500,000, in some cases up to 400,000 and in other cases up to 300,000. The weight average molecular weight of the elastomeric polymer can be any value or can range between any of the values recited above.

Non-limiting examples of suitable elastomeric polymers that can be used in the invention include the STEREON® polymers available from the Firestone Tire and Rubber Company, Akron, Ohio; the ASAPRENE™ polymers available from Asahi Kasei Chemicals Corporation, Tokyo, Japan; the KRATON® polymers available from Kraton Polymers, Houston, Tex.; the VECTOR® polymers available from Dexco Polymers LP, Houston, Tex.; and the Elvaloy® polymers available from E. I. du Pont de Nemours and Company, Wilmington, Del.

The polymer composition can be prepared by polymerizing the polymerization mixture in a suitable reactor under free radical polymerization conditions. When included, the elastomeric polymer can be added to a monomer mixture containing styrenic monomers and optionally maleate-type monomers and/or other monomers as a monomer feed, or can be added to or in the polymerization reactor vessel, or can be added to a partially polymerized syrup after it exits the reactor and enters a devolatilizer. It is also envisioned that, when included, the elastomeric polymers can be compounded, i.e., mixed into the polymer after the polymer has exited a devolatilizer, via an extruder, e.g., a twin-screw extruder, either in line or off line as a separate operation after the polymer has been pelletized.

The term “devolatilizer” and the term “devolatilizing system” as used herein are meant to include all shapes and forms of devolatilizers including an extruder and/or a falling strand flash devolatilizer. The term “devolatilizing” and the term “devolatilizing step” as used herein are meant to refer to a process, which can include an extruder and/or a falling strand flash devolatilizer.

In an embodiment of the invention, the elastomeric polymer is added to the reacting mixture of monomers before the devolatilization step to improve toughness, elongation, and heat distortion resistance properties of the resin composition and articles made according to the invention.

When elastomeric polymers are included, the absorbent clay is added to the resin composition either after the elastomeric polymer containing monomer mixture has been polymerized, after the elastomeric polymer has been blended or compounded into the polymer, or while the elastomeric polymer is being blended or compounded into the polymer.

Any suitable absorbent clay can be used in the invention. Suitable absorbent clays include, but are not limited to pyrophyllite, talc, vermiculite, sauconite, saponite, nontronite, montmorillonite, bentonite, kaolinite, dickite, halloysite, nacrite, and combinations thereof.

In a particular embodiment of the invention, the absorbent clay includes bentonite.

The absorbent clays are present in the resin composition at a level of at least 0.1%, in some cases at least 0.25%, in other cases at least 0.5%, in some instances at least 0.75% and in other instances at least 1% and can be present at up to 10%, in some cases up to 9%, in other cases up to 7%, and in some situations up to 5% by weight based on the weight of the resin composition. The absorbent clays can be present at any level or can range between any of the values recited above.

In the present invention, the absorbent clays act to “take up” or trap unreacted monomer or other low molecular weight organic materials, a non-limiting example being dimers of butadiene. This action by the absorbent clays acts to reduce any odor that may eminate from an article made from the present resin composition.

Although the inventors do not wish to be restricted to any single theory, it is believed that the unreacted monomer or other low molecular weight organic materials penetrate and become entrapped in the interlayer molecular spaces of the absorbent clay particles preventing the entrapped molecules from being emitted and causing an odor.

The resin composition of the invention can be prepared via polymerization techniques and compounding techniques, both of which are known to those skilled in the art.

The polymerization techniques used in polymerizing the components of the polymer composition of the invention can be solution, mass, bulk, suspension, or emulsion polymerization.

The polymer composition can be prepared by reacting styrenic monomers, and optionally maleate-type monomers and/or other monomers, and optionally elastomeric polymers in a suitable reactor under free radical polymerization conditions. Desirably, the maleate-type monomers are added to the styrenic monomers and the elastomeric polymer continuously at about the rate of reaction to a stirred reactor to form a polymer composition having a uniform maleate-type monomer level.

Polymerization of the polymerization mixture can be accomplished by thermal polymerization, generally between 50° C. and 200° C.; in some cases between 70° C. and 150° C.; and in other cases between 80° C. and 140° C. Alternately, free-radical generating initiators can be used.

Non-limiting examples of free-radical initiators that can be used include benzoyl peroxide, 2,4-dichlorobenzoyl peroxide, di-tert-butyl peroxide, tert-butyl peroxybenzoate, dicumyl peroxide, cumene hydroperoxide, diisopropylbenzene hydroperoxide, diisopropyl peroxydicarbonate, tert-butyl perisobutyrate, tert-butyl peroxyisopropylcarbonate, tert-butyl peroxypivalate, methyl ethyl ketone peroxide, stearoyl peroxide, tert-butyl hydroperoxide, lauroyl peroxide, azo-bis-isobutyronitrile and mixtures thereof.

Generally, the initiator is included in the range of 0.001 to 1.0% by weight, and, in some cases, on the order of 0.005 to 0.5% by weight of the polymerization mixture, depending upon the monomers and the desired polymerization cycle.

In an embodiment of the invention, the polymer composition is prepared by solution or bulk polymerization in the presence of from 0.01 to 0.1 weight % based on the mixture of a tetra functional peroxide initiator of the formula:

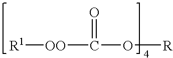

where R¹ is selected from C₄₋₆ t-alkyl radicals and R is a neopentyl group, in the absence of a crosslinking agent. In a particular embodiment of the invention, the tetrafunctional initiator is selected from the group consisting of tetrakis-(t-amylperoxycarbonyloxymethyl) methane, and tetrakis-(t-butylperoxycarbonyl-oxymethyl) methane.

In particular embodiments of the invention, the initiator is benzoyl peroxide.

In some cases, the required total amount of initiator is added simultaneously with the feedstock when the feedstock is introduced into the reactor.

Customary additives known in the art, such as stabilizers, antioxidants, lubricants, fillers, pigments, plasticizers, etc., can be added to the polymerization mixture. If desired, small amounts of antioxidants, such as alkylated phenols, e.g., 2,6-di-tert-butyl-p-cresol, phosphates such as trinonyl phenyl phosphite and mixtures containing tri (mono and dinonyl phenyl) phosphates, can be included in the feed stream. Such materials, in general, can be added at any stage during the polymerization process.

A polymerization reactor that can be used in producing the polymer composition of the invention is similar to that disclosed in the aforesaid U.S. Pat. Nos. 2,769,804 and 2,989,517, the teachings of which patents are incorporated in their entirety herein by reference. These configurations are adapted for the production, in a continuous manner, of solid, moldable polymers and copolymers of vinylidene compounds, particularly that of monovinyl aromatic compounds, i.e., styrene. Of these two arrangements, that of U.S. Pat. No. 2,769,804 is particularly desirable. Further, the polymer composition of the present invention can be prepared as disclosed in U.S. Pat. No. 7,294,676.

In general, the arrangement of U.S. Pat. No. 2,769,804 provides for an inlet or inlets for the monomers or feedstock connected to the polymerization reactor vessel. The reactor vessel is surrounded by a jacket, which has an inlet and an outlet for passage of a temperature control fluid through the jacket, and a mechanical stirrer. A valve line leads from a lower section of the vessel and connects with a devolatilizer, which can be any of the devices known in the art for the continuous vaporization and removal of volatile components from the formed resin exiting the vessel. For example, the devolatilizer can be a vacuum chamber through which thin streams of heated resin material pass, or a set of rolls for milling the heated polymer inside of a vacuum chamber, etc. The reactor is provided with usual means such as a gear pump for discharging the heat-plastified polymer from the reactor to the devolatilizer. A vapor line leads from the devolatilizer to a condenser, which condenses the vapors and effects the return of the recovered volatiles, e.g., monomeric material, typically in liquid condition as a recycle stream.

Thus, in embodiments of the invention, the polymerization can be carried out in bulk.

In other embodiments of the invention, the polymerization can be carried in a suspension or emulsion polymerization process. In this embodiment, a mixture of monomers and optionally elastomeric polymers is supplied to an agitated reaction vessel containing water, in many cases de-ionized, in the presence of a suspending agent. The mixture that forms contains droplets or particles containing the mixture in the aqueous continuous phase.

Suitable suspending agents are well known in the art. As a non-limiting example, the suspending agent can include partially hydrolyzed polyvinyl acetate. Typically, the amount of suspending agent that is used can be from about 0.07 to about 0.2 parts by weight per 100 parts by weight of water. In many cases, a buffering agent is also added to the emulsion or suspension. Suitable buffering agents include sodium carbonate, sodium dihydrogen phosphate, disodium hydrogen phosphate and mixtures of sodium dihydrogen and disodium hydrogen phosphate. A non-limiting example of a suitable buffering agent is a mixture of sodium dihydrogen phosphate and disodium hydrogen phosphate to buffer the aqueous phase to a pH of about 7. Polymer processing aids such as stearic acid or zinc stearate can be added to the aqueous phase. The processing aids can be used in an amount of about 0.1 to about 0.3 per cent by weight based on the feed mixture.

In embodiments of the invention, the polymerization can be carried out, as a non-limiting example, at a temperature of from about 75° C., in some cases from about 80° to about 95° C. and up to about 150° C. (when a pressurized reactor is utilized) for a time of from about 2 to about 7 hours, in some cases from about 4 to about 6 hours. Such polymerizations lead, in many cases, to at least some grafting of the monomers to the elastomeric polymers (when included), thereby developing small domains of elastomeric polymers having monomers grafted thereto distributed through the matrix of polymerizing and polymerized monomers.

Polymerization initiators or catalysts are often added to the aqueous phase to encourage or accelerate the polymerization process. Non-limiting examples of suitable initiators or catalysts include peroxidic and/or perester compounds, which can be added in an amount of from about 0.075 to about 0.4% by weight based on the feed mixture. Non-limiting examples of suitable peroxidic and perester compounds that can be used include benzoyl peroxide, dicumyl peroxide, lauroyl peroxide, t-butyl hydroperoxide and t-butyl perbenzoate. In particular embodiments of the invention, a mixture of a peroxide, such as benzoyl peroxide, and a perester, such as t-butyl perbenzoate is used, the amount of peroxide being from about 0.075 to about 0.4% by weight based on the feed mixture and the amount of perester being from about 0.05 to about 0.15% by weight based on the feed mixture.

The resulting polymer from the above-described processes can have a weight average molecular weight (Mw, measured using GPC with polystyrene standards) of at least 20,000, in some cases at least 35,000 and in other cases at least 50,000. Also, the Mw of the resulting polymer can be up to 1,000,000, in some cases up to 750,000, and in other cases up to 500,000. The Mw of the resulting polymer can be any value or range between any of the values recited above.

In an embodiment of the invention, a compounded blend can be used that includes the present resin composition and one or more other polymers. Suitable other polymers that can be blend compounded with the present resin composition include, but are not limited to crystal polystyrene, high impact polystyrenes, polyphenylene oxide, copolymers of styrene and maleic anhydride and/or C₁-C₁₂ linear, branched or cyclic alkyl (meth)acrylates, rubber-modified copolymers of styrene and maleic anhydride and/or C₁-C₁₂ linear, branched or cyclic alkyl (meth)acrylates, polycarbonates, polyamides (such as the nylons), polyesters (such as polyethylene terephthalate, PET), polyolefins (such as polyethylene, polypropylene, and ethylene-propylene copolymers), polyvinylidene fluoride, acrylonitrile/(meth)acrylate copolymers, ethylene/vinyl acetate copolymers, polyoxymethylene, acetal copolymer, ethylene vinyl alcohol copolymers, and combinations thereof.

In particular embodiments of the invention, the compounded blend includes polyoxymethylene (POM or Acetal), which, as a non-limiting example is available under the trade name DELRIN® from E.I. DuPont De Nemours and Company, Wilmington, Del.

When a compounded blend is used, the blend will typically include at least 10%, in some cases at least 25%, and in other cases at least 35% and up to 90%, in some cases up to 75%, and in other cases up to 65% by weight based on the blend of the present resin composition. Also, the blend will typically include at least 10%, in some cases at least 25%, and in other cases at least 35% and up to 90%, in some cases up to 75%, and in other cases up to 65% by weight based on the blend of the other polymers. The amount of the present resin composition and other polymers in the blend is determined based on the desired properties in the articles to be made using the blend composition. The amount of the present resin composition and other polymers in the blend can be any value or range between any of the values recited above.

Illustrative of blowing agents suitable to obtain a foam with a high open cell content of the present invention are chlorinated hydrocarbons such as methyl chloride, methylene chloride, and ethyl chloride; chlorofluorocarbons such as 1,1,1-trichloroethane, 1,1-dichloro-1-fluoroethane (HCFC-141b), 1,1-dichloro-2,2,2,-trifluoroethane (HCFC-123), chlorodifluoromethane (HCFC-22), and 1-chloro-1,2,2,2-tetrafluoroethane (HCFC-124); aliphatic hydrocarbons such as methane, ethane, propane, n-butane, isobutane, n-pentane, isopentane, and neopentane; fluorocarbons such as 1,1-difluoroethane (HFC-152a), 1,1,1-trifluoro-ethane (HFC-143a), 1,1,1,2-tetrafluoroethane (HFC-134a), and difluoromethane (HFC-32); alcohols, carbon dioxide (CO₂), water, and nitrogen. The blowing agents may be used alone or in combination. As a blowing agent to obtain a core material for a vacuum heat insulating material, one which quickly diffuses into the air from the inside of the foam is preferred. Illustrative of such blowing agents are chlorinated hydrocarbons such as methyl chloride, ethyl chloride, and ethylene chloride; alcohols, propane, dimethyl ether, methyl ethyl ether, diethyl ether, water, nitrogen, and carbon dioxide. The blowing agents may be used alone or in combination.

Above all, the blowing agent is preferably composed mainly of at least one blowing agent selected from chemical blowing agents, propane, methyl chloride, ethyl chloride dimethyl ether, methyl ethyl ether and diethyl ether because an open cell foam having a high open cell content can be easily obtained with a high productive efficiency. Especially preferred is the use of a blowing agent mainly composed of at least one blowing agent selected from methyl chloride, propane, and dimethyl ether because the foaming temperature range of these blowing agents is so wide that an open cell foam can be easily obtained. The blowing agent may contain 5-50 mol % of water, nitrogen or carbon dioxide to ensure safety against ignition and safety of humans and to obtain open cells more easily. To “be composed of at least one blowing agent” herein means to contain the blowing agent(s) at least 50 mol % when the total amount of the blowing agent is taken as 100mol %.

As used herein the term “chemical blowing agent” refers to a solid material included in a polymer composition or its precursors that is intended to decompose to form gases under certain conditions. As a non-limiting example, chemical blowing agents can thermally decompose generating gases such as nitrogen or carbon dioxide by the application of heat or through exothermic heat of reaction during polymerization. Non-limiting examples of chemical blowing agents that can be used in the invention include sodium bicarbonate and its mixture with citric acid, organic acid salts, azodicarbonamide, azobisformamide, azobisisobutyrolnitrile, diazoaminobenzene, 4,4′-oxybis(benzene sulfonyl hydrazide) (OBSH), N,N′-dinitrosopentamethyltetramine (DNPA), sodium borohydride, and combinations thereof.

The resin compositions and blends of the invention can also contain conventional additives known in the art such as heat stabilizers, light stabilizers, softening agents; plasticizers, dyes, pigments; anti-blocking agents; slip agents; lubricants; coloring agents; antioxidants; ultraviolet light absorbers; fillers; and anti-static agents and combinations thereof.

Non-limiting examples of suitable heat and light stabilizers include hindered amines, hindered phenols and phosphite or phosphonite stabilizers, which can be used in amounts of less than about 2 weight % based on the resin compositions and blends of the invention.

Non-limiting examples of suitable softening agents and plasticizers include cumarone-indene resin, a terpene resin, and oils, which can be used in an amount of about 2 parts by weight or less based on 100 parts by weight of the resin composition or blend.

Non-limiting examples of pigment include white pigments or pigments of any other color. The white pigment can be produced by the presence of titanium oxide, zinc oxide, magnesium oxide, cadmium oxide, zinc chloride, calcium carbonate, magnesium carbonate, etc., or any combination thereof in the amount of 0.1 to 20% in weight based on the resin compositions and blends of the invention, depending on the white pigment to be used. The colored pigment can be produced by carbon black, phtalocyanine blue, Congo red, titanium yellow or any other coloring agent known in the printing industry.

Examples of anti-blocking agents, slip agents or lubricants are silicone oils, liquid paraffin, synthetic paraffin, mineral oils, petrolatum, petroleum wax, polyethylene wax, hydrogenated polybutene, higher fatty acids and the metal salts thereof, linear fatty alcohols, glycerine, sorbitol, propylene glycol, fatty acid esters of monohydroxy or polyhydroxy alcohols, phthalates, hydrogenated castor oil, beeswax, acetylated monoglyceride, hydrogenated sperm oil, ethylenebis fatty acid esters, and higher fatty amides. The organic anti-blocking agents can be added in amounts that will fluctuate from 0.1 to 2% in weight based on the resin compositions and blends of the invention.

Examples of anti-static agents are glycerine fatty acid, esters, sorbitan fatty acid esters, propylene glycol fatty acid esters, stearyl citrate, pentaerythritol fatty acid esters, polyglycerine fatty acid esters, and polyoxethylene glycerine fatty acid esters. An anti-static agent can range from 0.01 to 2% in weight. Lubricants can range from 0.1 to 2% in weight. A flame retardant can range from 0.01 to 2% in weight; ultra-violet light absorbers can range from 0.1 to 4%; and antioxidants can range from 0.1 to 1% in weight. The above compositions are expressed as percent of the total weight of the resin compositions and blends of the invention.

Fillers, such as silica, alumina, calcium carbonate, talc, barium sulfate, metallic powder, glass spheres, and fiberglass, can be incorporated into the resin compositions and blends of the invention in order to reduce cost or to add desired properties to the resin or blend. The amount of filler often will be less than 10%, but in some instances can be used at up to 60%, in other instances up to 50%, in some cases up to 40%, in other cases up to 30%, and in some situations up to 20% based on total weight of the resin compositions or blend of the invention.

In embodiments of the invention, the present resin compositions and blends can be used to make a resin foam, and expandable resin bead, and/or a foam article. As such, a blowing agent is added to the present resin compositions or blends. In the present invention, the amount of the blowing agent, which is determined based on the density of the intended foam, is generally 0.05-2.5 mol per 1 kg of the resin or blend to obtain a foam with a density of 0.03-1.1 g/cm³, in some cases 0.04-0.9 g/cm³, and in other cases 0.05-0.8 g/cm³.

As used herein, the terms “expanded resin bead” and “expanded particle” refer to resin beads and/or particles that have been impregnated with a blowing agent, at least some of which is subsequently removed (as a non-limiting example heated and expanded followed by evaporation and diffusion out of the bead) in a way that increases the volume of the resin beads and/or particles and accordingly decreases their bulk density.

The expandable resin beads can be impregnated using any conventional method with a suitable blowing agent. Any gaseous material or material which will produce gases on heating can be used as the blowing agent. Conventional blowing agents include aliphatic hydrocarbons containing 4 to 6 carbon atoms in the molecule, such as butanes, pentanes, hexanes, and the halogenated hydrocarbons, e.g., CFC's and HCFC's, which boil at a temperature below the softening point of the polymer chosen. Mixtures of these aliphatic hydrocarbon blowing agents can also be used.

As a non-limiting example, liquid n-pentane or iso-pentane, or any mixture of liquid n-pentane and iso-pentane, can be used to impregnate the beads. The amount of absorbed blowing agent in the beads can be varied from 1% to 15%, in some cases from about 2% to 10% of the initial mass of non-impregnated beads.

Alternatively, water can be blended with these aliphatic hydrocarbons blowing agents or water can be used as the sole blowing agent as taught in U.S. Pat. Nos. 6,127,439; 6,160,027; and 6,242,540. In these patents, water-retaining agents are used. The weight percentage of water for use as the blowing agent can range from 1 to 20%. The texts of U.S. Pat. Nos. 6,127,439, 6,160,027 and 6,242,540 are incorporated herein by reference.

The resin beads of the present invention can be impregnated with any of the above blowing agents and can be stored, optionally for future expansion.

The resin beads are optionally expanded to a bulk density of at least 0.5 lb/ft³, in some cases at least 1.25 lb/ft³, in other cases at least 1.5 lb/ft³, in some situations at least 1.75 lb/ft³, in some circumstances at least 2 lb/ft³, in other circumstances at least 3 lb/ft³, and in particular circumstances at least 3.25 lb/ft³ or 3.5 lb/ft³. Also, the bulk density can be as high as 50 lb/ft³, in some situations 40 lb/ft³, in some instances up to 30 lb/ft³, in other instances up to 20 lb/ft³, in certain situations up to 12 lb/ft³, in some cases up to 10 lb/ft³, and in other cases up to 5 lb/ft³. The bulk density of the expanded resin beads can be any value or range between any of the values recited above.

The expansion step is conventionally carried out by heating the impregnated resin beads via any conventional heating medium, such as steam, hot air, hot water, or radiant heat. One generally accepted method for accomplishing the pre-expansion of impregnated resin beads is taught in U.S. Pat. No. 3,023,175.

The expanded resin beads can have an average particle size of at least 0.3, in some circumstances at least 0.5, in some cases at least 0.75, in other cases at least 0.9 and in some instances at least 1 mm and can be up to 15, in some circumstances up to 10, in other circumstances up to 6, in some cases up to 4, in other cases up to 3, and in some instances up to 2.5 mm. The average particle size of the expanded resin beads can be any value and can range between any of the values recited above. The average particle size of the expanded resin beads can be determined using laser diffraction techniques or by screening according to mesh size using mechanical separation methods well known in the art.

The expanded beads can have any density ranging from 0.6-6.0 pcf.

The expandable resin beads obtained according to the invention can be formed into a foamed shaped article of a desired configuration by pre-expanding the beads and foaming and shaping them in a mold cavity.

The present resin compositions or blends can be made into thermoplastic sheets. Desirably, the resin compositions or blends along with any additives used are combined, may be mixed on a heated mill roll or other compounding equipment, and the mixture cooled, granulated and extruded into a sheet. The formulation may be admixed in extruders, such as single-screw or double-screw extruders, compounded and extruded into pellets, which may be then re-fabricated. The extruder may also be used to extrude the composition as pipe, sheet, film or profile.

The resin compositions or blends can be extruded at a temperature that allows for formation of a sheet with the desired physical properties. In an embodiment of the invention, the resin compositions or blends are extruded at processable melt temperatures of from at least about 374° F. (190° C.), in some instances at least about 400° F. (204° C.), in some cases at least about 450° F. (232° C.) and up to about 590° F. (3 10° C.), in some instances about 550° F. (288° C.), in some cases up to about 500° F. (260° C.). The extrusion temperature can be any temperature or range between any of the temperatures indicated above and will depend on the particular composition of the polymers and/or resins used.

Films or sheets may be uniaxially or biaxially oriented either during extrusion or after such processing by reheating and stretching.

Granules of the resin compositions or blends can be molded or extruded into appropriate parisons which are then treated by conventional molding and blowing techniques into bottles or other containers, which containers may be stretch oriented uniaxially or biaxially, or may be left unoriented. It is known in the art for such containers to have closures that allow them to be sealed or capped.

Films or sheets can be formed into articles of desired shape by known processes such as plug assisted thermoforming where a plug pushes the film or sheet into a mold of the desired shape. Air pressure and/or vacuum can also be employed to mold the desired shape.

In embodiments of the invention, the various extruded or molded parts can be used as or incorporated into parts for use in the interior of an automobile.

As indicated above, the absorbent clays used in the present resin compositions and blends act to “take up” or trap unreacted monomer or other low molecular weight organic materials. This action by the absorbent clays acts to reduce any odor that may eminate from an article made from the present resin composition.

In embodiments of the invention, the resin compositions and blends according to the invention have a styrene monomer headspace value, determined by gas chromatography, of not more than 30 ppm, in some cases not more than 20 ppm, in other cases not more than 15 ppm, in some instances not more than 10 ppm, in other instances not more than 8 ppm and in particular situations not more than 6 ppm. The desired styrene monomer headspace value is determined based on the intended use of an article made using a resin composition or blend according to the invention. More particularly, the styrene monomer headspace value is determined in accordance with the automobile standard VDA 278 (as described in Volvo Corporate Standard STD 1027,2714, Issue 2, Established 2004-03).

In further embodiments of the invention, the resin compositions and blends according to the invention have a butadiene dimer headspace value determined by gas chromatography of not more than 5 ppm, in some cases not more than 4 ppm, in other cases not more than 3 ppm, in some instances not more than 2 ppm, in other instances not more than 1 ppm and in particular situations not more than 0.75 ppm. The desired butadiene dimer headspace value is determined based on the intended use of an article made using a resin composition or blend according to the invention. More particularly, the butadiene dimer headspace value is determined in accordance with the automobile standard VDA 278 (as described in Volvo Corporate Standard STD 1027,2714, Issue 2, Established 2004-03).

Advantageously, the resin compositions and blends according to the invention, in addition to having low odor, are able to maintain good physical properties. As a non-limiting example, the resin compositions and blends of the invention demonstrate a tensile strength of greater than 55 MPa, in some cases greater than 60 MPa, and in other cases greater than 70 MPa, as determined according to ISO 527-2 entitled “Plastics—Determination of tensile properties, Part 2: Test conditions for molding and extrusion plastics” (First Edition 1993-06-15).

Also, in embodiments of the invention, the resin compositions and blends of the invention demonstrate an Izod Impact value of greater than 5 kJ/m², in some cases greater than 6 kJ/m², and in other cases greater than 7.5 kJ/m² as determined according to ISO 180 entitled “Plastics—Determination of Izod impact strength, Amendment 1” (Third Edition 2000-12-15 with Amendment 1, 2006-12-01).

Thus, extruded or molded parts containing the resin compositions and/or blends according to the present invention can be used as or incorporated into parts for use in the interior of an automobile and provide desired strength properties while generating minimal VOC emissions.

More particularly, the addition of an absorbent clay at low levels (up to about 3 wt. %) in the present resin compositions and blends reduces the amount of VOC's emitted by the solid resin in gas chromatography testing by up to 40% and reduces the amount of VOC's in the headspace by 50%.

Butadiene dimer, although present at lower levels initially, has been identified as a significant source of odor in styrene-maleic anhydride polymer containing resins. Butadiene dimer concentrations in the headspace above the present resin compositions and blends is reduced by approximately 50%.

Low level inclusion of absorbent clay (up to 3 wt. %) results in no significant changes in the physical properties of the present resin compositions and blends.

Higher levels of absorbent clay (5 wt. % and higher) reduces the amount of residual styrene monomer emitted by the resin compositions or blends in GC testing by up to 90% and reduces the amount of styrene monomer in the headspace by 85%. Butadiene dimer concentrations in the headspace are reduced by approximately 70% at these levels. At higher absorbent clay levels, a slight decrease in notched impact properties can occur, while not significantly changing other physical properties.

For example, the tensile, flex, DTUL, and melt flow properties are not significantly impacted at any level of absorbent clay addition, and there are no significant changes in instrumented impact results at room temperature at levels of up to 5 wt. % absorbent clay.

The present invention will further be described by reference to the following examples. The following examples are merely illustrative of the invention and are not intended to be limiting. Unless otherwise indicated, all percentages are by weight.

### EXAMPLES

### Example 1

Using a volumetric feeder, powdered bentonite (National Standard Bentonite-325 mesh, BPM Minerals LLC, Aladdin, Wyo.) was added to a 34 mm co-rotating twin-screw extruder along with DYLARK® 378 resin (a styrene-maleic anhydride copolymer available from NOVA Chemicals Inc., Pittsburgh, Pa.) at the feed throat. Chopped strand fiberglass (Johns Manville Corporation, Denver, Colo.) was added downstream. Samples containing two, three, and five wt. % bentonite and no additive were compounded. All samples were compounded with a resultant melt temperature of 282° C.

The resulting pellets were injection molded into six-inch square plaques for instrumented impact testing and into ISO test specimens for physical testing. The neat DYLARK® 378 resin, all extruded pellet samples, and all molded samples were tested on using gas chromatography for residual styrene monomer concentrations. The neat DYLARK® 378 resin contained 1481 ppm of styrene. The molded samples were submitted for GC-Headspace analysis. A two-gram sample, taken from an injection-molded bar, was heated to 120° C. and held at temperature for 10 minutes. The amount of styrene monomer and butadiene dimer released by the sample into a 22 ml controlled headspace was measured. Results are shown in the tables below.

| | | DYLARK ® 378 resin | | | |
|---|---|---|---|---|---|
| | | | with Bentonite | | |
| | | no additive | 2 wt. % | 3 wt. % | 5 wt. % |
| Styrene Residuals | ppm | 613 | 443 | 362 | 52 |
| (GC-Pellets) | | | | | |
| Styrene Residuals | ppm | 562 | 408 | 302 | 55 |
| (GC-Molded Parts) | | | | | |
| Styrene Residuals | ppm | 5.45 | 2.45 | 2.35 | 0.75 |
| (Headspace) | | | | | |
| Butadiene Dimer | ppm | 0.13 | 0.02 | 0.05 | 0.03 |
| (Headspace) | | | | | |

Specific gravity was determined according to ISO 1183, Melt flow was determined according to ISO 1133, Tensile properties were determined according to ISO 527-2, Flexural properties were determined according to ISO 178 and IZOD impact was measured according to ISO 180-1A.

| | | DYLARK ® 378 resin | | | |
|---|---|---|---|---|---|
| | | | with Bentonite | | |
| | | no additive | 2 wt. % | 3 wt. % | 5 wt. % |
| Specific Gravity | | 1.17 | 1.19 | 1.18 | 1.21 |
| Melt Flow | | 3.1 | 3.1 | 3.1 | 3.4 |
| Tensile Strength | MPa | 66.2 | 66.4 | 63.3 | 61.4 |
| Tensile | % | 2.1 | 1.9 | 2.0 | 1.8 |
| Elongation | | | | | |
| Tensile | MPa | 5669 | 5934 | 5704 | 6036 |
| Modulus | | | | | |
| Flexural | MPa | 97 | 97.9 | 91.9 | 91.8 |
| Strength | | | | | |
| Flexural | MPa | 4662 | 4891 | 4599 | 4905 |
| Modulus | | | | | |
| Izod Impact | kJ/m² | 7.7 | 7.1 | 6.5 | 5.7 |
| @ 23 C. | | | | | |

The addition of bentonite to the styrene-maleic anhydride resin had a significant impact on the amount of emitted VOCs from the final resin compared to the styrene-maleic anhydride resin alone. Bentonite additions of approximately three weight percent reduced the residual styrene monomer emission by 40% in solvent based GC testing. Increasing the bentonite loadings to a nominal 5 wt % reduced the residual styrene monomer emission by 90% in solvent based GC testing.

In GC-Headspace testing, bentonite additions of nominally three weight percent reduced the styrene monomer headspace concentration by 50%, and increased bentonite additions of up to 5 wt % reduced the styrene monomer headspace concentration by 85%.

Concentrations of butadiene dimer in the headspace were decreased by the addition of bentonite. Bentonite additions of a nominal 3 wt % reduced the butadiene dimer concentration in the headspace by 50%. Increased bentonite additions of 5 wt % reduced the butadiene dimer concentration in the headspace by 70%.

Flexural properties, were statistically unchanged by the addition of bentonite. The tensile strength decreased by 5% and the tensile elongation decreased by 10% at the highest bentonite loadings. As a result, the tensile modulus increased by approximately 5%. In these formulations, the impact of bentonite addition on tensile performance was not significant.

At nominal bentonite loadings of 2 to 3 wt %, the notched Izod impact are statistically similar to the control. Nominal bentonite addition of 5 wt % reduced the notched Izod impact by approximately 18%.

### Example 2

Using a gravimetric feeder, powdered bentonite was added to a 70 mm co-rotating twin-screw extruder along with DYLARK® 378 resin and ethylene-(meth)acrylate rubber at the feed throat. Chopped strand fiberglass was added downstream. A sample containing five wt. % bentonite was compounded (Sample A), and the styrene monomer content and volatile emissions were compared against a DYLARK® 378P15 (Sample B, styrene-maleic anhydride copolymer available from NOVA Chemicals Inc.) control sample. All experimental samples were compounded with a resultant melt temperature of 263° C.

The resulting pellets were injection molded into six-inch square plaques for instrumented impact testing and into ISO test specimens for physical testing. The material was molded into plaques with 3.2 mm thickness, and 30 mg pieces were obtained from the sample using a hollow punch. Each 30 mg piece was placed in a sealed glass tube for VDA 278 emissions testing. The VDA 278 styrene emissions were measured at 5 ppm. The typical result from 378P15 is 40 ppm.

Specific gravity was determined according to ISO 1183, Melt flow was determined according to ISO 1133, Tensile properties were determined according to ISO 527-2, Flexural properties were determined according to ISO 178 and IZOD impact was measured according to ISO 180-1A. Results are summarized in the table below.

Formulation

| | | Sample A | Sample B |
|---|---|---|---|
| Styrene Residuals (GC- | ppm | 150 | 400 |
| Specific | | 1.23 | 1.18 |
| Melt Flow | g/10 | 0.41 | 0.39 |
| Tensile | MPa | 59.7 | 63.1 |
| Tensile | % | 2.1 | 2.0 |
| Tensile | MPa | 543 | 520 |
| Flexural | MPa | 97.2 | 102. |
| Flexural | MPa | 520 | 493 |
| Izod Impact @ | kJ/m\hat{ } | 9.1 | 7.7 |
| Izod Impact @- | kJ/m\hat{ } | 6.7 | 7.3 |
| Charpy Impact @ 23 C. | kJ/m\hat{ } | 9.0 | 7.7 |
| Charpy Impact @ 23 C. | kJ/m\hat{ } | 25.7 | 22.8 |
| DTUL @ 1.82 | C | 121. | 121. |

The addition of 5 wt. % bentonite to the styrene-maleic anhydride resin had a significant impact on the amount of emitted VOC's compared with the styrene-maleic anhydride resin control. Flexural and tensile strength properties remained acceptable compared to the control sample. Thus, the impact of bentonite addition on tensile and flexural performance was not significant. At the 5 wt. % bentonite loading, the notched Izod impact, Charpy Impact and DTUL were statistically similar to the control.

The present invention has been described with reference to specific details of particular embodiments thereof. It is not intended that such details be regarded as limitations upon the scope of the invention except insofar as and to the extent that they are included in the accompanying claims.

What is claimed is:

1. A resin composition comprising:
a) about 65% to about 99.9% by weight of a polymer formed by polymerizing a mixture comprising:
i) about 35% to about 100% by weight of one or more styrenic monomers,
ii) optionally about 1% to about 49% by weight of one or more maleate-type monomers, and
iii) optionally about 1% to about 65% by weight of one or more other polymerizable monomers;
b) optionally about 0.1% to about 30% by weight of one or more elastomeric polymers; and
c) about 0.1% to about 10% by weight of an absorbent clay.

2. The resin composition according to claim 1, wherein the absorbent clay is one or more selected from the group consisting of pyrophyllite, talc, vermiculite, sauconite, saponite, nontronite and montmorillonite, kaolinite, dickite, halloysite, nacrite, and combinations thereof.

3. The resin composition according to claim 1, wherein the clay comprises bentonite.

4. The resin composition according to claim 1, wherein the styrenic monomers are selected from the group consisting of styrene, p-methyl styrene, α-methyl styrene, tertiary butyl styrene, dimethyl styrene, nuclear brominated or chlorinated derivatives thereof and combinations thereof.

5. The resin composition according to claim 1, wherein the maleate-type monomers are selected from the group consisting of maleic anhydride, maleic acid, fumaric acid, C₁-C₁₂ linear, branched or cyclic alkyl esters of maleic acid, C₁-C₁₂ linear, branched or cyclic alkyl esters of fumaric acid, itaconic acid, C₁-C₁₂ linear, branched or cyclic alkyl esters of itaconic acid, and itaconic anhydride.

6. The resin composition according to claim 1, wherein the elastomeric polymers are selected from the group consisting of homopolymers of butadiene or isoprene, and random, block, AB diblock, or ABA triblock copolymers of a conjugated diene with a styrenic monomer and/or acrylonitrile.

7. The resin composition according to claim 1, wherein the elastomeric polymers are one or more block copolymers selected from the group consisting of diblock and triblock copolymers of styrene-butadiene, styrene-butadiene-styrene, styrene-isoprene, styrene-isoprene-styrene, partially hydrogenated styrene-isoprene-styrene and combinations thereof.

8. The resin composition according to claim 1, wherein the other monomers are one or more selected from the group consisting of divinylbenzene, conjugated dienes, alkyl methacrylates, alkyl acrylates, acrylonitrile, alpha olefins, and combinations thereof.

9. The resin composition according to claim 1 comprising one or more additives selected from the group consisting of heat stabilizers, light stabilizers, softening agents; plasticizers, dyes, pigments; anti-blocking agents; slip agents; lubricants; coloring agents; antioxidants; ultraviolet light absorbers; fillers; anti-static agents; impact modifiers, and combinations thereof.

10. The resin composition according to claim 1, wherein the weight average molecular weight of the copolymer is from about 20,000 to about 1,000,000.

11. The resin composition according to claim 1 having a styrene monomer headspace value determined by gas chromatography of not more than 30 ppm.

12. The resin composition according to claim 1 having a butadiene dimer headspace value determined by gas chromatography of not more than 5 ppm.

13. The resin composition according to claim 1 having a tensile strength of greater than 55 MPa determined by ISO 527-2 (First Edition 1993-06-15).

14. The resin composition according to claim 1 having an Izod Impact value of greater than 5 kJ/m² determined by ISO 180 (Third Edition 2000-12-15 with Amendment 1, 2006-12-01).

15. A molded article comprising the resin according to claim 1.

16. A resin foam comprising the resin according to claim 1.

17. A method of reducing the odor of a resin comprising adding about 0.1% to about 10% by weight of an absorbent clay to the resin.

18. The method according to claim 17, wherein the absorbent clay is one or more selected from the group consisting of pyrophyllite, talc, vermiculite, sauconite, saponite, nontronite and montmorillonite, kaolinite, dickite, halloysite, nacrite, and combinations thereof.

19. The method according to claim 17, wherein the clay comprises bentonite.

20. The method according to claim 17, wherein the monomer headspace value determined by gas chromatography for the resin is not more than 30 ppm.
